(19) United States
(12) Patent Application Publication
(10) Pub. No.: US 2024/0295205 A1
(43) Pub. Date: Sep. 5, 2024

(54) FUEL SYSTEM HAVING FUEL INJECTOR BOOT ASSEMBLY WITH INTEGRATED FILTER

(71) Applicant: Caterpillar Inc., Peoria, IL (US)

(72) Inventor: Kenth I. Svensson, Peoria, IL (US)

(73) Assignee: Caterpillar Inc., Peoria, IL (US)

(21) Appl. No.: 18/116,386

(22) Filed: Mar. 2, 2023

(51) Int. Cl. F02M 61/16; F02M 51/06

(52) U.S. Cl. CPC F02M 61/165; F02M 51/061

(57) ABSTRACT

A boot in a fuel system includes a boot wall having a window formed therein receiving an electrical connector of a fuel injector, and a filter attached to the boot wall. An air gap is defined between the fuel injector and the boot, and a filtered air flow path extends through the filter to the air gap. The boot may be implemented in an assembly of a fuel injector and a double-walled fuel conduit such as in a fuel system for an internal combustion engine.

### TECHNICAL FIELD

The present disclosure relates generally to a boot in a fuel system, and more particularly to a boot and attached filter.

### BACKGROUND

The fuel system in a modern internal combustion engine is often the most complex and expensive part of the equipment. Fuel is typically pressurized to a range of pressures depending upon application and injection location, and delivered for combustion in one or more shots of fuel into a cylinder by way of precisely controlling electrically and/or hydraulically actuated components in fuel injectors. Pressurized fuel systems can require specialized sealing and fuel containment apparatus. For regulatory and other purposes higher pressure portions of a fuel system often employ double-walled containment, such that in the event of a liquid fuel and/or fuel vapor leak fuel is contained in a secondary system outside of the highly pressurized portions and can be returned to a fuel tank or otherwise safely handled.

A component known as a boot is sometimes used in pressurized fuel systems and can assist in positioning and/or protecting certain components, including fuel injectors and fuel connections. An example boot employed in a fuel system is known from co-pending application Ser. No. 17/895,564, filed Aug. 25, 2022, to Wiebrecht. While the designs proposed in Wiebrecht offer promise, there is always room for improvement and development of alternative strategies.

### SUMMARY OF THE INVENTION

In one aspect, a fuel system includes a fuel injector including an injector housing having a fuel inlet and a fuel outlet formed therein, and an electrical connector projecting from the injector housing. The fuel system further includes a fuel conduit connected to the fuel injector, and a boot positioned about the fuel injector and the fuel conduit. The boot includes a boot wall having a window formed therein receiving the electrical connector, and a filter attached to the boot wall. An air gap is defined between the fuel injector and the boot, and a filtered air flow path extends through the filter to the air gap.

In another aspect, a boot assembly for a fluid system includes an elongate boot body defining a longitudinal axis and including a boot wall extending circumferentially around the longitudinal axis and forming a central cavity extending axially between an open first axial end and an open second axial end. The boot wall has formed therein a window at a location axially between the open first axial end and the open second axial end, and an air opening at a location that is at least one of circumferentially offset or axially offset from the window. The boot assembly further includes a filter attached to the elongate boot body so as to form a filtered air flow path through the air opening into the central cavity.

In still another aspect, a boot for a fuel injector and fuel conduit assembly includes an elongate boot body defining a longitudinal axis and including a boot wall extending circumferentially around the longitudinal axis and forming a central cavity extending axially between an open first axial end and an open second axial end. The boot wall has formed therein a window at a location axially between the open first axial end and the open second axial end, and an air opening at a location that is at least one of circumferentially offset or axial offset from the window. The boot further includes a filter holder attached to the boot wall and positioned adjacent to the opening.

### BRIEF DESCRIPTION OF THE DRAWINGS

FIG. 1 is a diagrammatic view of an engine system according to one embodiment;

FIG. 2 is a sectioned side diagrammatic view of a portion of the engine system of FIG. 1:

FIG. 3 is a diagrammatic view of a boot assembly, according to one embodiment:

FIG. 4 is another diagrammatic view of a boot assembly as in FIG. 3:

FIG. 5 is a sectioned view through a portion of a boot assembly, according to one embodiment; and

FIG. 6 is a diagrammatic view of a filter installed in a filter holder of a boot, according to one embodiment.

### DETAILED DESCRIPTION

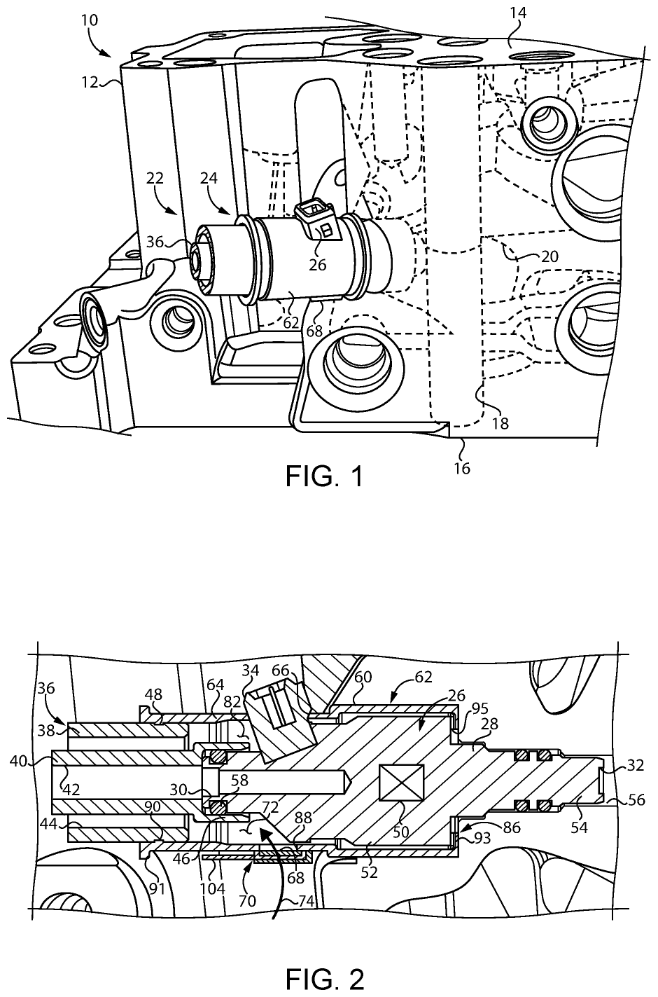

Referring to FIG. 1, there is shown an internal combustion engine system 10, according to one embodiment. Engine system 10 includes a cylinder head 12 having an upper cylinder head surface 14, a lower cylinder head surface 16, and bolt bores 18 for extending between upper cylinder head surface 14 and lower cylinder head surface 16. Other typical features for transfer of fluids including engine coolant and/or oil may extend through cylinder head 12. Cylinder head 12 may be a cylinder head section associated with one combustion cylinder in a cylinder block, or a slab cylinder head associated with multiple combustion cylinders. Engine system 10 may be implemented in a variety of applications, including for electrical power generation, for propelling a land vehicle or a marine vessel, or operating a pump or compressor to name a few examples. Engine system 10 may include any number of combustion cylinders in any suitable arrangement, such as an inline pattern, a V-pattern, or still another. Engine system 10 may be operated on a liquid primary fuel, and dual-fuel pilot ignited using a compression-ignition liquid fuel, although the present disclosure is not thereby limited. A spark-ignited strategy is also within the scope of the present disclosure. An example liquid primary fuel includes methanol, although the present disclosure is also not thereby limited in this regard.

Cylinder head 12 further includes one or more intake ports 20 formed therein. In a practical implementation engine system 10 is port-injected with liquid methanol fuel. The methanol fuel may be ignited by way of a compression-ignited direct injection of a diesel distillate fuel or ignited via dimethyl ether for example. As will be further apparent from the following description engine system 10 is uniquely configured by way of fuel system apparatus for containment of liquid fuel and fuel vapors as well as ventilation of fuel supply and containment apparatus. While aspects of the present disclosure are described in the context of a fuel system, in other instances teachings herein could be applied in a different type of fluid system, such as system supplying and delivering oil in an engine or other machinery context, or still other environments.

To this end, engine system 10 further includes a fuel system 22. Fuel system 22 includes a fuel injector and conduit assembly 24. Referring also now to FIG. 2, assembly 24 includes a fuel injector 26, and fuel injector 26 includes an injector housing 28 having a fuel inlet 30 and a fuel outlet 32 formed therein, and an electrical connector 34 projecting from injector housing 28. Fuel injector 26 also includes an electrically actuated valve assembly 50. Fuel injector 26 may be a fuel injector of known design having a known configuration and operation of valve assembly 50 to inject a fuel, such as methanol, from fuel outlet 32 into a fuel port 56 in cylinder head 12 that fluidly connects to intake port 20. An example fuel injector construction is set forth in co-pending application Ser. No. 17/895,564, referenced above.

Fuel system 22 and assembly 24 further include a fuel conduit 36 connected to fuel injector 26. Fuel conduit 36 may include a double-walled fuel conduit having an outer wall 38 and an inner wall 40 defining a fuel supply passage 42 fluidly connected to fuel inlet 30, and also to a fuel pressurization pump and a liquid fuel supply such as a methanol fuel tank (not shown). An interwall space 44 typically having the form of an annulus is defined between outer wall 38 and inner wall 40. In a practical implementation strategy, a vacuum is drawn on interwall space 44 such that a negative pressure is continuously applied. In the event of fuel leakage the negative pressure can assist in ensuring that any leaked liquid fuel and/or vapors can be returned to a fuel tank, for example, or safely discharged to ambient. Inner wall 40 may further include an injector fitting 46 coupled to and in contact with a body portion 52 of fuel injector 26. A tip portion 54 of fuel injector 26 projects into fuel port 56. An O-ring 58 may be provided to seal between injector fitting 46 and body portion 52.

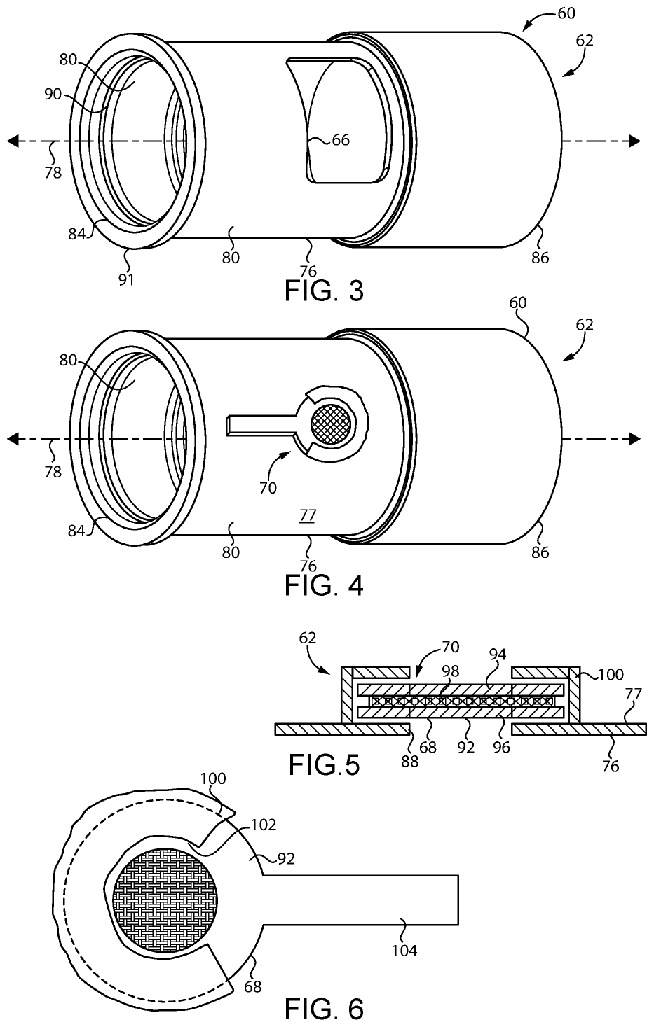

Assembly 24 further includes a boot 60. Boot 60 forms, together with fuel injector 26, a boot assembly 62. Boot 60 is positioned about fuel injector 26 and fuel conduit 36, and includes a boot wall 64. Referring also now to FIGS. 3 and 4, boot wall 64 has a window 66 formed therein receiving electrical connector 34. Electrical connector 34 may be fluidly sealed with boot 60 within window 66. Boot 60 and boot assembly 62 may also include a filter 68 in a filter assembly 70 attached to boot wall 64. An air gap 72 is defined between fuel injector 26 and boot 60. As illustrated in FIG. 2, a filtered air flow path 74 extends through filter 68 to air gap 72. In this general fashion air drawn through boot 60 and into interwall space 44 is filtered to prevent admission of debris or the like.

Boot 60 further includes an elongate boot body 76. Boot 60 and boot body 76 are referred to, at times, interchangeably herein. Boot body 76 defines a longitudinal axis 78. Boot wall 80 includes an outer surface 77 and extends circumferentially around longitudinal axis 78 and forms a central cavity 82 extending axially between an open first axial end 84 and an open second axial end 86. A projecting annular flange is shown at 91 in FIG. 2. Open second axial end 86 includes a radially inward wall 93 forming an opening 95. Boot wall 80 further includes an air opening 88 formed therein at a location that is at least one of circumferentially offset or axially offset from window 66. In the illustrated embodiment air opening 88 is located approximately opposite to window 66 circumferentially around longitudinal axis 78. As can be seen in FIG. 2 boot body 76 further includes an annular protrusion or tab 90 extending circumferentially around longitudinal axis 78 and received in a groove 48 formed in outer wall 38.

Referring also now to FIGS. 5 and 6, filter 68 may further include a frame 92, having an upper frame piece 94 and a lower frame piece 96. Filter 68 may also include a filter medium 98, such as a metallic mesh filter medium sandwiched between upper frame piece 94 and lower frame piece 96. Frame 92 may be annular and extends around filter medium 98. One particular implementation employs annular washers for each of upper frame piece 94 and lower frame piece 96, spot welded together and sandwiching filter medium 98 therebetween. As an alternative to spot welding, frame pieces 94 and 96 could be attached using a suitable adhesive. Filter 68 could also be embedded in material from which boot 60 is formed, such as by way of injection molding. The present disclosure is not limited with regard to the manner by which filter 68 is coupled to boot 60 nor the manner by which filter 68 is constructed.

Boot 60 may further include a filter holder 100. Filter holder 100 may include a pocket 102 with filter 68 received in pocket 102 and positioned across air opening 88. Filter 68 may be interference-fitted in filter holder 100. Also in the illustrated embodiment, filter holder 100 may be formed integrally with boot body 76, and formed on outer surface 77 of boot body 76.

Focusing on FIG. 6, boot body 76 may be formed of a deformable, non-metallic material such as natural rubber or a suitable natural or synthetic rubber-like material including any of a variety of different polymeric materials readily commercially available. Frame 92 may be formed of a not deformable material, relative to the deformable non-metallic material of boot body 76, such as a suitable metallic material. It can be readily envisioned from FIG. 6 that filter 68 can be slid to the left into filter holder 100 and deform the material of filter holder 100 to interference fit filter 68 therein. A protruding tab, handle, or similar piece 104 may extend from frame 92 and facilitates installation and deinstallation of filter 68. Other strategies for removably or releasably connecting filter 68 to boot 60 are within the scope of the present disclosure.

### INDUSTRIAL APPLICABILITY

Referring to the drawings generally, during service in engine system 10 filter 68 may accumulate debris that eventually reduces air flow into air gap 72 and limits a flow of air through interwall space 44. It may thus be desirable to swap out filter 68 at a periodic service interval, or when it is otherwise apparent that filter 68 should be changed such as after visual inspection. A user can grasp tab 104 and pull filter 68 out of filter holder 100, and install a replacement filter therein.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A fuel system comprising:
a fuel injector including an injector housing having a fuel inlet and a fuel outlet formed therein, and an electrical connector projecting from the injector housing;
a fuel conduit connected to the fuel injector;
a boot positioned about the fuel injector and the fuel conduit, and including a boot wall having a window formed therein receiving the electrical connector, and a filter attached to the boot wall; and
an air gap is defined between the fuel injector and the boot, and a filtered air flow path extends through the filter to the air gap.

2. The fuel system of claim 1 wherein the boot wall further includes an air opening formed therein, and the filter is positioned across the air opening.

3. The fuel system of claim 2 wherein the filter includes a frame, and a filter medium supported by the frame.

4. The fuel system of claim 3 wherein the frame is annular and extends around the filter medium.

5. The fuel system of claim 2 wherein the boot further includes a filter holder, and the filter is interference-fitted in the filter holder.

6. The fuel system of claim 5 wherein the filter holder includes a pocket, and the filter is interference-fitted in the pocket.

7. The fuel system of claim 1 wherein the fuel conduit includes a double-walled fuel conduit having an inner wall and an outer wall and the air gap is fluidly connected to an interwall space.

8. The fuel system of claim 1 wherein a fluid seal is formed between the electrical connector and the boot.

9. A boot assembly for a fluid system comprising:
an elongate boot body defining a longitudinal axis and including a boot wall extending circumferentially around the longitudinal axis and forming a central cavity extending axially between an open first axial end and an open second axial end;
the boot wall having formed therein a window at a location axially between the open first axial end and the open second axial end, and an air opening at a location that is at least one of circumferentially offset or axially offset from the window; and
a filter attached to the elongate boot body so as to form a filtered air flow path through the air opening into the central cavity.

10. The boot assembly of claim 9 wherein the elongate boot body includes a filter holder, and the filter is removably mounted in the filter holder.

11. The boot assembly of claim 10 wherein the filter holder is formed on an outer surface of the elongate boot body.

12. The boot assembly of claim 11 wherein the filter includes a frame and a mesh filter medium attached to the frame.

13. The boot assembly of claim 12 wherein:
the frame is annular and extends circumferentially around the filter medium;
the elongate boot body is formed of a deformable non-metallic material; and
the frame is formed of a not deformable material, and includes an upper frame piece and a lower frame piece sandwiching the filter medium therebetween.

14. The boot assembly of claim 10 wherein the filter is interference-fitted in the filter holder, and the filter includes a protruding installation-deinstallation tab.

15. The boot assembly of claim 9 wherein the window and the air opening are arranged opposite to one another circumferentially around the longitudinal axis.

16. A boot for a fuel injector and fuel conduit assembly comprising:
an elongate boot body defining a longitudinal axis and including a boot wall extending circumferentially around the longitudinal axis and forming a central cavity extending axially between an open first axial end and an open second axial end;
the boot wall having formed therein a window at a location axially between the open first axial end and the open second axial end, and an air opening at a location that is at least one of circumferentially offset or axially offset from the window; and
a filter holder attached to the boot wall and positioned adjacent to the opening.

17. The boot of claim 16 wherein the open first axial end includes a wall extending radially inward and defining a first opening, and the open second axial end includes a radially outward flange and defines a second opening larger than the first opening.

18. The boot of claim 17 wherein the open second axial end includes an annular protrusion extending circumferentially around the longitudinal axis, and radially inward into the central cavity.

19. The boot of claim 16 wherein the boot wall includes an outer surface, and an inner surface forming the central cavity, and the filter holder is formed integrally with the elongate body and includes a pocket formed on the outer surface.

20. The boot of claim 16 wherein the pocket extends greater than 180° and less than 360° circumferentially around the air opening.
